(19) United States
(12) Patent Application Publication
(10) Pub. No.: US 2014/0267876 A1
(43) Pub. Date: Sep. 18, 2014

(54) CAMERA MODULE

(71) Applicants: HON HAI PRECISION INDUSTRY CO., LTD., New Taipei (TW); HONG FU JIN PRECISION INDUSRY (ShenZhen) CO., LTD., Shenzhen (CN)

(72) Inventor: WEI CHEN, Shenzhen (CN)

(73) Assignees: HON HAI PRECISION INDUSTRY CO., LTD., New Taipei (TW); HONG FU JIN PRECISION INDUSRY (ShenZhen) CO., LTD., Shenzhen (CN)

(21) Appl. No.: 13/967,350

(22) Filed: Aug. 15, 2013

(30) Foreign Application Priority Data
Mar. 18, 2013 (CN) 2013100854356

(51) Int. Cl. H04N 5/225

(52) U.S. Cl. CPC H04N 5/2254
USPC 348/335

(57) ABSTRACT

A camera module includes a housing, a wafer level module (WLM), a liquid crystal panel, and an image sensor. The housing includes a top surface and a bottom surface facing away from the top surface. The housing defines a through hole running through the top surface and the bottom surface. The WLM is received in the through hole, and includes a lens barrel and at least one lens received in the lens barrel. The lens barrel includes an upper surface and a lower surface facing away from the upper surface. The liquid crystal panel is received in the through hole and positioned on the upper surface. The image sensor is received in the through hole and connected to the lower surface.

### BACKGROUND

1. Technical Field

The present disclosure relates to a camera module.

2. Description of Related Art

The development of MEMS (Micro Electro Mechanical System) technology, has made microstructures, ultra-micro actuators, various ultra-micro sensors, micro optical parts, micro fluid devices and the like, common in manufacture.

Recently, due to MEMS, electronic products with a camera module have become cheaper and thus more popular. However, the demand for ever smaller products that still include camera modules has increased but is difficult to meet because the focus modules used in the camera cameras require gears, cams, motors and so on, which take up a lot of space.

Therefore, it is desirable to provide a camera module that can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a camera module, according to an exemplary embodiment.

FIG. 2 is an exploded, isometric view of the camera module of FIG. 1.

FIG. 3 is similar to FIG. 2, but viewed from another angle.

FIG. 4 is a cross-sectional view taken along line IV-IV of FIG. 1.

FIG. 5 is a cross-sectional view of a liquid crystal panel of FIG. 4.

### DETAILED DESCRIPTION

FIGS. 1-3 show a camera module 100. The camera module 100 includes a housing 10, a wafer level module (WLM) 20, an image sensor 30, a liquid crystal panel 40, and an aperture plate 50.

In the embodiment, the housing 10 is made of liquid crystal polymer (LCP) and is black[[opaque?]]. The housing 10 is substantially cuboid and includes two first sidewalls 101, two second sidewall 102 connected substantially perpendicularly to the first sidewalls 101, a top surface 103, and a bottom surface 104 facing away from the top surface 103. The two first sidewalls 101 are substantially parallel with each other. The two second sidewalls 102 are substantially parallel with each other. Both the top surface 103 and the bottom surface 104 are substantially rectangular.

The housing 10 defines a receiving hole 105 running through the top surface 103 and the bottom surface 104. In the embodiment, the receiving hole 105 is stepped. The receiving hole 105 includes a first receiving hole 1051 close to the top surface 103, a second receiving hole 1052 close to the bottom surface 104, and a third receiving hole 1053 positioned between the first receiving hole 1051 and the second receiving hole 1052. A cross-section area of the first receiving hole 1051 is substantially equal to that of the second receiving hole 1052. A cross-section area of the third receiving hole 1053 is slightly smaller than that of the first receiving hole 1051. As such, the housing 10 also includes a stepped surface 1054 between the first receiving hole 1051 and the third receiving hole 1053. The stepped surface 1054 is substantially parallel with the top surface 103.

Also referring to FIGS. 4-5, the WLM 20 includes a hollow lens barrel 201 and at least one lens 202 received in the lens barrel 201. The lens barrel 201 is a hollow cylinder and includes a main body 201a and an annular aperture portion 201b. The annular aperture portion 201b is positioned at the object-side end of the main body 201a and is integrally formed with the main body 201a. The annular aperture portion 201b defines an aperture opening 2014 at the center thereof to allow light rays from objects of interest (not shown) to enter the lens barrel 201. In particular, the aperture opening 2014 tapers towards the image-side of the lens barrel 201, which is beneficial for controlling the angle of incidence of the light rays entering thereinto. An inner sidewall 200a of the main body 201a is black, which efficiently absorbs rays of incident light to improve the image quality of the camera module 100. The WLM 20 includes an upper surface 2011 and a lower surface 2012 facing away from the upper surface 2011.

A shape and a size of the lens barrel 201 respectively correspond to a shape and a size of the third receiving hole 1053. As such, the lens barrel 201 is received in the third receiving hole 1053. The upper surface 2011 of the lens barrel 201 is coplanar with the stepped surface 1054. The lower surface 2012 is received in the second receiving hole 1052.

The image sensor 30 is a charge-coupled device (CCD), or a complementary metal-oxide-semiconductor transistor (CMOS). The image sensor 30 is configured to convert light signals received from the WLM 20 into digital electrical signals. The image sensor 30 has a photosensitive area 3011 configured for receiving light signals transmitted through the WLM 20, and a non-photosensitive area 3012 surrounding the photosensitive area 3011. A shape and a size of the image sensor 30 respectively correspond to a shape and a size of the second receiving hole 1052. The image sensor 30 is received in second receiving hole 1052, with the non-photosensitive area 3012 directly connected to the lower surface 2012 of the lens barrel 201, and the lens barrel 201 surrounding the photosensitive area 3011.

In the embodiment, the liquid crystal panel 40 is a transmission type liquid crystal panel, and includes a frame 401, a first alignment layer 402, a second alignment 403, a first indium tin oxide (ITO) electrode layer 404 and a second ITO electrode layer 405, a first transparent plate 406, and a second transparent plate 407. The liquid crystal panel 40 also includes liquid crystals 408 packaged in the frame 401. The first and second alignment layers 402 and 403 are positioned on opposite sides of the frame 401. The first ITO electrode layer 404 is positioned on a surface of the first alignment layer 402 facing away from the frame 401. The second ITO electrode layer 405 is positioned on a surface of the second alignment layer 403 facing away from the frame 401. The first transparent plate 406 is positioned on a surface of the first ITO electrode layers 404 facing away from the first alignment layer 402. The first transparent plate 406 includes a light input surface 4061. The second transparent plate 407 is positioned on a surface of the second ITO electrode layers 405 facing away from the second alignment layer 403. The second transparent plate 407 includes a light output surface 4071.

The camera module 100 also includes two electrodes 60 and a power source 70. The first ITO electrode layer 404 is electrically connected to the power source 70 through one of the electrodes 60. The second ITO electrode layer 405 is electrically connected to the power source 70 through the other electrode 60.

The liquid crystal panel 40 is substantially cuboid. A shape and a size of the liquid crystal panel 40 are respectively corresponding to a shape and a size of the first receiving hole 1051. The liquid crystal panel 40 is received in the first receiving hole 1051, and aligns with the at least one lens 202. An optical axis of the liquid crystal panel 40 is coaxial with an optical axis of the at least one lens 202. The light input surface 4061 faces away from the upper surface 2011. The light output surface 4071 is supported on the stepped surface 1054 and the upper surface 2011 of the lens barrel 20.

The aperture plate 50 is positioned on the top surface 103 of the housing 10 and faces the light input surface 4016. The aperture plate 50 is ring-shaped and is made of an opaque material, such as polyethylene terephthalate (PET) or poly carbonate (PC), to block light rays transmitted in the lens barrel 201. The aperture plate 50 defines an aperture hole 501 corresponding to the aperture opening 2014.

In use, light passes through the aperture hole 501 of the aperture plate 50 and strikes the light input surface 4061. The first and second ITO electrode layers 404 and 405 gain a driving voltage through the electrodes 60 and the power source 70, to change a refractive index of the liquid crystal 408. As such, the liquid crystal panel 40 has a zooming function. Then the refracted light is output through the light output surface 4062 to enter into the lens barrel 201 through the aperture opening 2014, and is focused by the lens 202. The focused light finally strikes the photosensitive area 3011 of the image sensor 30.

It is noteworthy that, in alternative embodiments, the aperture plate 50 can be omitted.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A camera module comprising:
a housing comprising a top surface and a bottom surface facing away from the top surface, the housing defining a through hole running through the top surface and the bottom surface;
a wafer level module (WLM) received in the through hole, and comprising a lens barrel and at least one lens received in the lens barrel, the lens barrel comprising an upper surface and a lower surface facing away from the upper surface;
a liquid crystal panel received in the through hole and positioned on the upper surface; and
an image sensor received in the through hole and connected to the lower surface.

2. The camera module of claim 1, wherein the housing is made of liquid crystal polymer and is opaque.

3. The camera module of claim 1, wherein the receiving hole is a stepped, and comprises a first receiving hole close to the top surface, a second receiving hole close to the bottom surface, and a third receiving hole positioned between the first receiving hole and the second receiving hole.

4. The camera module of claim 3, wherein the liquid crystal panel is received in the first receiving hole, the image sensor is received in the second receiving hole, the lens barrel is received in the third receiving hole.

5. The camera module of claim 4, wherein a cross-section area of the third receiving hole is slightly smaller than a cross-section area of the first receiving hole, the housing comprises a stepped surface between the first receiving hole and the third receiving hole, the stepped surface is substantially parallel with the top surface.

6. The camera module of claim 5, wherein the upper surface of the lens barrel is coplanar with the stepped surface, the liquid crystal panel is supported by the stepped surface and the upper surface.

7. The camera module of claim 1, wherein the image sensor comprises a photosensitive area and a non-photosensitive area surrounding the photosensitive area, the photosensitive area is configured for receiving light signals transmitted through the WLM, the non-photosensitive area directly connects to the lower surface of the lens barrel, and the lens barrel surrounds the photosensitive area.

8. The camera module of claim 1, wherein the liquid crystal panel comprises a frame, a first alignment layer, a second alignment, a first indium tin oxide (ITO) electrode layer and a second ITO electrode layer, a first transparent plate, and a second transparent plate, the liquid crystal panel also comprises liquid crystals packaged in the frame, the first and second alignment layers are respectively positioned on two opposite sides of the frame, the first ITO electrode layer is positioned on a surface of the first alignment layer facing away from the frame, the second ITO electrode layer is positioned on a surface of the second alignment layer facing away from the frame, the first transparent plate is positioned on a surface of the first ITO electrode layers facing away from the first alignment layer, the second transparent plate is positioned on a surface of the second ITO electrode layers facing away from the second alignment layer.

9. The camera module of claim 8, wherein the first transparent plate comprises a light input surface facing away from the upper surface, the second transparent plate comprises a light output surface supported by the upper surface.

10. The camera module of claim 8, comprising two electrodes and a power source, wherein the first ITO electrode layer is electrically connected to the power source through one of the electrode, the second ITO electrode layer is electrically connected to the power source through the other electrode, the first and second ITO electrode layers gain a driving voltage through the electrodes and the power source, to change a refractive index of the liquid crystals.

11. The camera module of claim 1, comprising an aperture plate, wherein the aperture plate is positioned on the top surface of the housing.

12. The camera module of claim 11, wherein the lens barrel is a hollow cylinder in shape and comprises a main body and an annular aperture portion, the annular aperture portion is positioned at an object-side end of the main body, the annular aperture portion defines an aperture opening, the aperture plate defines an aperture hole corresponding to the aperture opening.
